(19) United States
(12) Patent Application Publication
(10) Pub. No.: US 2009/0173253 A1
(43) Pub. Date: Jul. 9, 2009

(54) Coating materials containing mixed oxide nanoparticles consisting of 50-99.9 % by weight al203 and 0.1-50 % by weight oxides of elements of main groups l or ll of the periodic table

(76) Inventors: Norbert Roesch, Gersthofen (DE); Ernst Krendlinger, Friedberg (DE); Anja Heinze, Meitingen/Erlingen (DE); Karl Zeisberger, Gersthofen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/990,360

(22) PCT Filed: Aug. 16, 2006
(86) PCT No.: PCT/EP2006/008066

§ 371 Date: Feb. 16, 2009

(30) Foreign Application Priority Data
Aug. 18, 2005 (DE) 102005039436.1
May 10, 2006 (DE) 102006021705.5

(51) Int. Cl. C09D 1/00

(52) U.S. Cl. 106/286.5

(57) ABSTRACT

The invention relates to coating materials containing mixed oxide nanoparticles, an organic binder and possibly additives, wherein said coating materials contain the nanoparticles consisting of 50-99.9% by weight aluminium oxide and 0.1-50 % by weight oxide of elements of the I or II main group of the periodic system. The mixed oxide nanoparticles can also have a surface modified by another coating agent, preferably silane or siloxane. The inventive mixed oxide nanoparticles provide coating materials or to coatings with an improved scratch resistance.

Known are coating materials comprising nanoparticles, the nanoparticles being prepared by means of sol-gel technology, by hydrolytic (co-)condensation of tetraethoxysilane (TEOS) with other metal alkoxides in the absence of organic and/or inorganic binders. From DE 199 24 644 it is known that the sol-gel synthesis can also be carried out in the medium. Preference is given to using radiation-curing formulations. All materials prepared by means of sol-gel operation, however, are distinguished by low solids contents in terms of organic and inorganic solids, by increased amounts of the condensation product (generally alcohols), by the presence of water, and by limited storage stability.

A step forward is represented by the high-temperature-resistant, reactive metal oxide particles prepared by hydrolytic condensation of metal alkoxides on the surface of nanoscale inorganic particles in the presence of reactive binders. The temperature resistance of the fully reacted formulations is achieved through the heterogeneous copolymerization of reactive groups of the medium with reactive groups of the binder that are of the same kind. A disadvantage here is the incompleteness of the heterogeneous copolymerization, where not all of the reactive groups on the surface of the particles take part in the copolymerization. Steric hindrances are primarily the reason. As is known, however, the groups that have not fully reacted lead to unwanted secondary reactions, possibly giving rise to discoloration, embrittlement or premature degradation. This is so in particular for high-temperature applications. Even the process described in DE 198 46 660 leads to systems which are not storage-stable, owing to the acidic medium in the presence of the condensation product (generally alcohols).

Also known are nanoscale surface-modified particles (Degussa Aerosil® R 7200) formed by condensation of metal oxides with silanes in the absence of a binder and thus in the absence of strong shearing forces of the kind which act in viscous media at stirring speeds of ≧10 m/s. These Aerosils for this reason possess larger particles than the raw materials employed; their opacity is much higher and their activity is lower than the action of the particles described in WO 00/22052 and of the varnishes produced from them.

It is an object of the invention to eliminate the disadvantages of the prior art and to provide storage-stable and property-stable coating compositions which comprise specially produced nanoscale inorganic particles.

The invention provides coating compositions comprising mixed oxide nanoparticles consisting of 50%-99.9% by weight of aluminum oxide and 0.1%-50% by weight of oxides of elements of main group I or II of the periodic table of the elements. According to one further embodiment of the invention the mixed oxide nanoparticles may also be modified on the surface with another coating material.

The aluminum oxide in these mixed oxides is preferably predominantly in the rhombohedral α modification (corundum). The mixed oxides according to the present invention preferably have a crystallite size of less than 1 μm, more preferably less than 0.2 μm, and with particular preference between 0.001 and 0.09 μm. Inventive particles of this order of size will be referred to below as mixed oxide nanoparticles.

The mixed oxide nanoparticles of the invention can be prepared by different processes described below. These process descriptions refer to the preparation only of pure aluminum oxide particles, although it is obvious that, for all of these process versions, not only Al-containing starting compounds but also those compounds of elements of main group I or II of the periodic table of the elements must be present in order to form the mixed oxides of the invention. Particularly suitable for this purpose are preferably the chlorides, but also the oxides, oxide chlorides, carbonates, sulfates or other suitable salts. The amount of such oxide formers is calculated such that the completed nanoparticles contain the aforementioned amounts of oxide MeO.

Very generally speaking, the preparation of the nanoparticles of the invention starts from relatively large agglomerates of these mixed oxides, which are subsequently deagglomerated to the desired particle size. These agglomerates may be prepared by processes described below.

Such agglomerates can be prepared, for example, by a variety of chemical syntheses. In a majority of cases these are precipitation reactions (hydroxide precipitation, hydrolysis of organometallic compounds) with subsequent calcination. In the course of these reactions, crystallization nuclei are frequently added in order to lower the temperature of conversion to the α-aluminum oxide. The sols thus obtained are dried, in the course of which they are converted to a gel. Further calcination then takes place at temperatures between 350° C. and 650° C. For the conversion to α-Al₂O₃ it is then necessary to carry out calcination at temperatures around 1000° C. The processes are comprehensibly described in DE 199 22 492.

Another route is the aerosol process. In that case the desired molecules are obtained from chemical reactions of a precursor gas or by means of rapid cooling of a supersaturated gas. The particles are formed either by collision or by the continual vaporization and condensation—present in equilibrium—of clusters of molecules. The newly formed particles grow by further collision with product molecules (condensation) and/or particles (coagulation). If the coagulation rate is greater than that of new formation and/or of growth, then agglomerates of spherical primary particles are formed.

Flame reactors represent one preparation variant based on this principle. Here, nanoparticles are formed by the decomposition of precursor molecules in the flame at 1500° C.-2500° C. Examples include the oxidations of TiCl₄; SiCl₄ and Si₂O(CH₃)₆ in methane/O₂ flames, leading to TiO₂ and SiO₂ particles. Using AlCl₃, it has been possible to date to produce only the corresponding alumina. Flame reactors are nowadays used industrially for the synthesis of submicroparticles such as carbon black, pigmentary TiO₂, silica, and alumina.

Small particles can also be formed from droplets, with the aid of centrifugal force, compressed air, sound, ultrasound, and other methods. The droplets are then converted to powder by direct pyrolysis or by reactions in situ with other gases. Known processes include spray-drying and freeze-drying. In the case of spray pyrolysis, precursor droplets are transported through a high-temperature field (flame, oven), which leads to rapid vaporization of the volatile component or which initiates the decomposition reaction to give the desired product. The desired particles are collected in filters. One example of this is the preparation of BaTiO₃ from an aqueous solution of barium acetate and titanium lactate.

By grinding it is likewise possible to attempt to comminute corundum and, in so doing, to produce crystallites in the nano-range. The best grinding results can be obtained with stirred ball mills in a wet grinding operation. In that case it is necessary to use grinding beads made of material harder than corundum.

A further route to the production of corundum at low temperature is the conversion of aluminum chlorohydrate. For this purpose the chlorohydrate is likewise admixed with seed nuclei, preferably of ultrafine corundum or hematite. To avoid crystal growth, the samples must be calcined at temperatures of around 700° C. up to a maximum of 900° C. The duration of calcination in this case is at least four hours. A disadvantage of this method is therefore the high time expenditure and the residual quantities of chlorine in the alumina. The method has been comprehensively described in Ber. DKG 74 (1997) No. 11/12, pp. 719-722.

From these agglomerates it is necessary to release the nanoparticles. This is accomplished preferably by grinding or by treatment with ultrasound. In accordance with the invention this deagglomeration takes place in the presence of a solvent and, where appropriate, of a coating material for modifying the surface, preferably a silane or siloxane, which during the grinding operation saturates the active and reactive surfaces which form, this saturation taking place by means of a chemical reaction or physical addition, and so preventing reagglomeration. The nano-mixed oxide is retained as a small particle. It is also possible to add the surface-modifying coating material after deagglomeration has taken place.

In the context of the preparation of the mixed oxides according to the invention it is preferred to start from agglomerates prepared in accordance with the information in Ber. DKG 74 (1997) No. 11/12, pp. 719-722, as described above.

The starting point in this case is aluminum chlorohydrate, of the formula Al₂(OH)ₓCl_{y}, where x is a number from 2.5 to 5.5 and y is a number from 3.5 and 0.5, and the sum of x and y is always 6. This aluminum chlorohydrate, in the form of an aqueous solution, is mixed with crystallization nuclei, and then dried and subsequently subjected to thermal treatment (calcination).

In this case it is preferred to start from approximately 50% strength aqueous solutions of the kind available commercially. A solution of this kind is admixed with crystallization nuclei which promote the formation of the α modification of Al₂O₃. More particularly such nuclei bring about a reduction in the temperature for the formation of the α modification in the course of the subsequent thermal treatment. Suitable nuclei include, preferably, very finely dispersed corundum, diaspore or hematite. Particular preference is given to using very finely disperse α-Al₂O₃ nuclei having an average particle size of less than 0.1 μm. In general 2% to 3% by weight of nuclei is sufficient, based on the aluminum oxide formed.

This initial solution further comprises oxide formers, in order to generate the oxides MeO in the mixed oxide. Particularly suitable for this purpose are the chlorides of the elements of main groups I and II of the periodic table of the elements, more particularly the chlorides of the elements Ca and Mg, but also, furthermore, soluble or dispersible salts such as oxides, oxychlorides, carbonates or sulfates. The amount of oxide former is calculated such that the completed nanoparticles contain 0.01% to 50% by weight of the oxide of Me. The main group I and II oxides may be present as a separate phase alongside the aluminum oxide, or may form true mixed oxides with it, such as spinels, etc., for example. The term “mixed oxides” in the context of this invention should be understood to include both types.

This suspension of aluminum chlorohydrate, nuclei and oxide formers is then evaporated to dryness and subjected to a thermal treatment (calcination). This calcination takes place in an apparatus suitable for the purpose, as for example in push-through, chamber, tube, rotary tube or microwave furnaces or in a fluidized-bed reactor. In one version of the process of the invention it is also possible to inject the aqueous suspension of aluminum chlorohydrate, oxide formers, and nuclei into the calcining apparatus directly, without removing the water beforehand.

The temperature for the calcination should not exceed 1400° C. The lower temperature limit is dependent on the desired yield of nanocrystalline mixed oxide, on the desired residual chlorine content, and on the amount of nuclei. The formation of the nanoparticles commences at about 500° C., but in order to keep the chlorine content low and the nanoparticle yield high it is preferred to operate at 700 to 1100° C., more particularly at 1000 to 1100° C.

It has surprisingly emerged that generally 0.5 to 30 minutes, preferably 0.5 to 10, more particularly 2 to 5 minutes are sufficient for calcination. Even after this short time it is possible, under the conditions stated above for the preferred temperatures, to achieve a sufficient yield of nanoparticles. An alternative option is to carry out calcining in accordance with the information in Ber. DKG 74 (1997) No. 11/12, p. 722, for 4 hours at 700° C. or 8 hours at 500° C.

In the calcination, agglomerates in the form of virtually spherical nanoparticles are obtained. These particles are composed of Al₂O₃ and MeO. The presence of MeO acts as an inhibitor on crystal growth, and keeps the crystallite size small. This distinguishes the agglomerates of the kind obtained by the above-described calcination clearly from the particles of the kind used in the process described in WO 2004/069 400, which are relatively coarse, inherently homogeneous particles, and not agglomerates of prefabricated nanoparticles.

To obtain nanoparticles, the agglomerates are comminuted preferably by wet grinding in a solvent, as for example in an attritor mill, bead mill or stirred mill. This gives mixed oxide nanoparticles having a crystallite size of less than 1 μm, preferably less than 0.2 μm, with particular preference between 0.001 and 0.9 μm. Thus, for example, after grinding for six hours, a suspension of nanoparticles having a d90 value of approximately 50 nm is obtained. Another possibility for deagglomeration is that of sonication with ultrasound.

If it is desired to modify the surface of these nanoparticles with coating materials, such as silanes or siloxanes, for example, there are two possibilities. According to the first, preferred variant, the deagglomeration can be performed in the presence of the coating material: for example, by adding the coating material to the mill during grinding. A second possibility is first to disintegrate the nanoparticle agglomerates and then to treat the nanoparticles, preferably in the form of a suspension in a solvent, with the coating material.

Suitable solvents for the deagglomeration include not only water but also conventional solvents, preferably those which are also used in the coatings industry, such as, for example, C₁-C₄ alcohols, more particularly methanol, ethanol or isopropanol, acetone, tetrahydrofuran, and butyl acetate. If deagglomeration takes place in water, an organic or inorganic acid should be added, such as HCl, HNO₃, formic acid or acetic acid, for example, in order to stabilize the resulting nanoparticles in the aqueous suspension. The amount of acid can be 0.1% to 5% by weight, based on the mixed oxide. After that, preferably, the grain fraction having a particle diameter of less than 20 nm is separated from this aqueous suspension of acidically modified nanoparticles, by means of centrifuging. Subsequently, at an elevated temperature, as for example at about 100° C., the coating material, preferably a silane or siloxane, is added. The nanoparticles thus treated are precipitated, separated off, and dried to a powder, by means of freeze-drying, for example.

Suitable coating materials in this context are preferably silanes or siloxanes or mixtures thereof.

Further suitable coating materials are all substances which are able to attach physically to the surface of the mixed oxides (adsorption) or which are able to attach to the surface of the mixed oxide particles by the formation of a chemical bond. Since the surface of the mixed oxide particles is hydrophilic and since there are free hydroxyl groups available, suitable coating materials are alcohols, compounds containing amino, hydroxyl, carbonyl, carboxyl or mercapto functions, silanes or siloxanes. Examples of such coating materials are polyvinyl alcohol, mono-, di-, and tricarboxylic acids, amino acids, amines, waxes, surfactants, hydroxycarboxylic acids, organosilanes and organosiloxanes.

Suitable silanes and siloxanes are compounds of the formulae
a) R[—Si(R′R″)—O—]ₙSi(R′R″)—R′″ or cyclo-[—Si(R′R″)—O—]ᵣ(R′R″)—O—
   in which
   R, R′, R″, and R′″, identical or different from one another, are each an alkyl radical having 1-18 C atoms or a phenyl radical or an alkylphenyl or a phenylalkyl radical having 6-18 C atoms, or a radical of the general formula —(CₘH₂ₘ—O)ₚ—C_{q}H_{2q+1} or a radical of the general formula —CₛH₂ₛY or a radical of the general formula —XZₜ₋₁,
   n is an integer having the definition 1≦n≦1000, preferably 1≦n≦100,
   m is an integer 0≦m≦12 and
   p is an integer 0≦p≦60 and
   q is an integer 0≦q≦40 and
   r is an integer 2≦r≦10 and
   s is an integer 0≦s≦18, and
   Y is a reactive group, examples being α,β-ethylenically unsaturated groups, such as (meth)acryloyl, vinyl or allyl groups, amino, amido, ureido, hydroxyl, epoxy, isocyanato, mercapto, sulfonyl, phosphonyl, trialkoxysilyl, alkyldialkoxysilyl, dialkylmonoalkoxysilyl, anhydride and/or carboxyl groups, imido, imino, sulfite, sulfate, sulfonate, phosphine, phosphite, phosphate, phosphonate groups, and
   X is a t-functional oligomer, where
   t is an integer 2≦t≦8, and
   Z in turn is a radical

R[—Si(R′R″)—O—]ₙSi(R′R″)—R′″ or cyclo-[—Si(R′R″)—O—]ᵣSi(R′R″)—O—

as defined above.

The t-functional oligomer X is preferably selected from:

oligoethers, oligoesters, oligoamide, oligourethane, oligourea, oligoolefin, oligovinyl halide, oligovinylidene dihalide, oligoimine, oligovinyl alcohol, esters, acetal or ethers of oligovinyl alcohol, cooligomers of maleic anhydride, oligomers of (meth)acrylic acid, oligomers of (meth)acrylic esters, oligomers of (meth)acrylamides, oligomers of (meth)acrylimides, oligomers of (meth)acrylonitrile, with particular preference oligoethers, oligoesters, oligourethanes.

Examples of radicals of oligoethers are compounds of the type —(CₐH₂ₐ—O)_{b}—CₐH₂ₐ— and O—(CₐH₂ₐ—O)_{b}—CₐH₂ₐ—O with 2≦a≦12 and 1≦b≦60, e.g., a diethylene glycol, triethylene glycol or tetraethylene glycol radical, a dipropylene glycol, tripropylene glycol, tetrapropylene glycol radical, a dibutylene glycol, tributylene glycol or tetrabutylene glycol radical. Examples of radicals of oligoesters are compounds of the type —C_{b}H_{2b}—(C(CO)CₐH₂ₐ—(CO)O—C_{b}H_{2b}—)_{c}— and —O—C_{b}H_{2b}—(C(CO)CₐH₂ₐ—(CO)O—C_{b}H_{2b}—)_{c}—O— with a and b, differently or identically, 3≦a≦12, 3≦b≦12, and 1≦c≦30, e.g., an oligoester of hexanediol and adipic acid.
b) Organosilanes of the type (RO)₃Si(CH₂)ₘ—R′
   R=alkyl, such as methyl, ethyl, propyl
   m=0.1-20
   R′=methyl, phenyl,
   —C₄F₉; OCF₂—CHF—CF₃, —C₅F₁₃, —O—CF₂—CHF₂
   —NH₂, —N₃, SCN, —CH═CH₂, —NH—CH₂—CH₂—NH₂,
   —N—(CH₂—CH₂—NH₂)₂
   —OOC(CH₃)C═CH₂
   —OCH₂—CH(O)CH₂
   —NH—CO—N—CO—(CH₂)₅
   —NH—COO—CH₃, —NH—COO—CH₂—CH₃, —NH—(CH₂)₃Si(OR)₃
   Sₓ—(CH₂)₃)Si(OR)₃
   —SH
   —NR′R″R′″ (R′=alkyl, phenyl; R″=alkyl, phenyl; R′″=H, alkyl, phenyl, benzyl,
   C₂H₄NR″″ with R″″=A, alkyl and R″″=H, alkyl).

Examples of silanes of the type defined above are, for example, hexamethyldisiloxane, octamethyltrisiloxane, further homologous and isomeric compounds of the series SiₙOₙ₋₁(CH₃)₂ₙ₊₂, where

n is an integer 2≦n≦1000, e.g., polydimethylsiloxane 200® fluid (20 cSt).

Hexamethyl-cyclo-trisiloxane, octamethyl-cyclo-tetrasiloxane, further homologous and isomeric compounds of the series

(Si—O)ᵣ(CH₃)₂ᵣ, where
r is an integer 3≦r≦12,
dihydroxytetramethyldisiloxane, dihydroxyhexamethyltrisiloxane, dihydroxyoctamethyltetrasiloxane, further homologous and isomeric compounds of the series
HO—[(Si—O)ₙ(CH₃)₂ₙ]—Si(CH₃)₂—OH or
HO—[(Si-o)ₙ(CH₃)₂ₙ]—[Si—O)ₘ(C₆H₅)₂ₘ]—Si(CH₃)₂—OH, where
m is an integer 2≦m≦1000,
preference being given to the α,ω-dihydroxypolysiloxanes, e.g., polydimethylsiloxane (OH end groups, 90-150 cST) or polydimethylsiloxane-co-diphenylsiloxane (dihydroxy end groups, 60 cST).

Dihydrohexamethyltrisiloxane, dihydrooctamethyltetrasiloxane, further homologous and isomeric compounds of the series

H—[(Si—O)ₙ(CH₃)₂ₙ]—Si(CH₃)₂—H, where
n is an integer 2≦n≦1000, preference being given to the α,ω-dihydropolysiloxanes, e.g., polydimethylsiloxane (hydride end groups, Mₙ=580).

Di(hydroxypropyl)hexamethyltrisiloxane, di(hydroxypropyl)octamethyltetrasiloxane, further homologous and isomeric compounds of the series HO—(CH₂)ᵤ[(Si—O)ₙ(CH₃)₂(CH₂)ᵤ—OH, preference being given to the α,ω-dicarbinol polysiloxanes with 3≦u≦18, 3≦n≦1000, or their polyether-modified successive compounds based on ethylene oxide (EO) and propylene oxide (PO) in the form of a homopolymer or copolymer HO-(EO/PO)ᵥ—(CH₂)ᵤ[(Si—O)ₜ(CH₃)₂ₜ]—Si(CH₃)₂(CH₂)ᵤ-(EO/PO)ᵥ—OH, preference being given to α,ω-di(carbinol polyether)-polysiloxanes with 3≦n≦1000, 3≦u≦18, 1≦v≦50.

Likewise employed instead of α,ω-OH groups are the corresponding difunctional compounds with epoxy, isocyanato, vinyl, allyl, and di(meth)acryloyl groups, examples being polydimethylsiloxane with vinyl end groups (850-1150 cST) or TEGORAD 2500 from Tego Chemie Service.

Also suitable are the esterification products of ethoxylated/propoxylated trisiloxanes and higher siloxanes with acrylic acid copolymers and/or maleic acid copolymers as a modifying compound, e.g., BYK Silclean 3700 from Byk Chemie or TEGO® Protect 5001 from Tego Chemie Service GmbH.

Likewise employed instead of α,ω-OH groups are the corresponding difunctional compounds with —NHR″″ with R″″═H or alkyl, examples being the common-knowledge aminosilicone oils from the companies Wacker, Dow Corning, Bayer, Rhodia, etc., these compounds carrying, on their polymer chain, (cyclo)alkylamino groups or (cyclo)alkylimino groups distributed randomly on the polysiloxane chain.
c) Organosilanes of the type (RO)₃Si(CₙH₂ₙ₊₁) and (RO)₃Si(CₙH₂ₙ₊₁), where
   R is an alkyl, such as methyl, ethyl, n-propyl, isopropyl, butyl, and
   n is 1 to 20.

Organosilanes of the type R′x(RO)ySi(CnH2n+1) and (RO)3Si(CnH2n+1),

where
R is an alkyl, such as methyl, ethyl, n-propyl, isopropyl, butyl,
R′ is an alkyl, such as methyl, ethyl, n-propyl, isopropyl, butyl,
R′ is a cycloalkyl
n is an integer of 1-20
x+y is 3
x is 1 or 2
y is 1 or 2
d) Organosilanes of the type (RO)₃Si(CH₂)ₘ—R′, where
   R is an alkyl, such as methyl, ethyl, propyl,
   m is a number between 0.1-20
   R′ is methyl, phenyl, —C₄F₉; OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃)Si(OR)₃, —SH—NR′R″′R′″ (R′=alkyl, phenyl; R″=alkyl, phenyl; R′″=H, alkyl, phenyl, benzyl, C₂H₄NR″″R′″″ with R″″=A, alkyl and R′″″=H, alkyl).

Preferred silanes are the silanes listed below:

triethoxysilane, octadecyltrimethoxysilane, 3-(trimethoxysilyl)propyl methacrylates, 3-(trimethoxysilyl)propyl acrylates, 3-(trimethoxysilyl)methyl methacrylates, 3-(trimethoxysilyl)methyl acrylates, 3-(trimethoxysilyl)ethyl methacrylates, 3-(trimethoxysilyl)ethyl acrylates, 3-(trimethoxysilyl)pentyl methacrylates, 3-(trimethoxysilyl)pentyl acrylates, 3-(trimethoxysilyl)hexyl methacrylates, 3-(trimethoxysilyl)hexyl acrylates, 3-(trimethoxysilyl)butyl methacrylates, 3-(trimethoxysilyl)butyl acrylates, 3-(trimethoxysilyl)heptyl methacrylates, 3-(trimethoxysilyl)heptyl acrylates, 3-(trimethoxysilyl)octyl methacrylates, 3-(trimethoxysilyl)octyl acrylates, methyltrimethoxysilanes, methyltriethoxysilanes, propyltrimethoxysilanes, propyltriethoxysilanes, isobutyltrimethoxysilanes, isobutyltriethoxysilanes, octyltrimethoxysilanes, octyltriethoxysilanes, hexadecyltrimethoxysilanes, phenyltrimethoxysilanes, phenyltriethoxysilanes, tridecafluoro-1,1,2,2-tetra-hydrooctyltriethoxysilanes, tetramethoxysilanes, tetraethoxysilanes, oligomeric tetraethoxysilanes (DYNASIL® 40 from Degussa), tetra-n-propoxysilanes,
3-glycidyloxypropyltrimethoxysilanes, 3-glycidyloxypropyltriethoxysilanes, 3-methacryloyloxypropyltrimethoxysilanes, vinyltrimethoxysilanes, vinyltriethoxysilanes, 3-mercaptopropyltrimethoxysilanes, 3-aminopropyltriethoxysilanes, 3-aminopropyltrimethoxysilanes, 2-aminoethyl-3-aminopropyltrimethoxysilanes, triamino-functional propyltrimethoxysilanes (DYNASYLAN® TRIAMINO from Degussa), N-(n-butyl)-3-aminopropyltrimethoxysilanes, 3-aminopropylmethyldiethoxysilanes.

The coating materials, in this case more particularly the silanes or siloxanes, are added preferably in molar ratios of mixed oxide nanoparticle to silane of 1:1 to 10:1. The amount of solvent during the deagglomerating is generally 80% to 90% by weight, based on the total amount of mixed oxide nanoparticles and solvent.

The deagglomeration by grinding and simultaneous modification with the coating material takes place preferably at temperatures from 20 to 150° C., with particular preference at 20 to 90° C.

Where deagglomeration takes place by grinding, the suspension is subsequently separated from the grinding beads.

After the deagglomeration the reaction can be completed by heating the suspension for up to 30 hours more. To end with, the solvent is removed by distillation and the residue that remains is dried. It may also be advantageous to leave the modified mixed oxide nanoparticles in the solvent and to use the dispersion for further applications.

It is also possible to suspend the mixed oxide nanoparticles in the corresponding solvents and to carry out the reaction with the coating material after the deagglomeration, in a further step.

The surface-modified mixed oxide nanoparticles thus prepared can be incorporated into any desired coating compositions, such as, for example, ceramic coatings, Eloxal coatings or, preferably, into varnishes. These coating compositions further comprise conventional binders, examples being those described below:

Film-forming binders for one-component and multicomponent polymer systems may include the following components known from coatings technology:

alkyd-melamine baking varnishes, mono- or polyfunctional acrylates, examples being butyl acrylate, ethylhexyl acrylate, norbornyl acrylate, butanediol diacrylate, hexanediol diacrylate, dipropylene glycol diacrylate, tripropylene glycol diacrylate, trimethylolpropane triacrylate, trimethylolpropane triethoxytriacrylate, pentaerythritol tetraethoxytriacrylate, pentaerythritol tetraethoxytetraacrylate, polyether acrylate, polyether acrylate, polyurethane acrylates, e.g., Craynor® CN 925, CN 981 from Cray Valley Kunstharze GmbH, Ebecryl® EB 1290 from UCB GmbH, Laromer 8987 from BASF AG, Photomer® 6019 or Photomer® 6010 from Cognis,
polyester acrylates, e.g., Craynor® CN 292 from Cray Valley Kunstharze GmbH, Laromer® LR 8800 from BASF AG, Ebecryl® EB 800 from UCB GmbH, Photomer® 5429 F and Photomer® 5960 F from Cognis,
epoxy acrylates, e.g., Laromer® EA 81 from BASF AG, Ebecryl® EB 604 from UCB GmbH, Craynor® CN104D80 from Cray Valley Kunstharze GmbH,
dendritic polyester/ether acrylates from Perstorp Speciality Chemicals AG or from Bayer AG,
polyurethane polymers and their precursors in the form of the polyisocyanates, polyols, polyurethane prepolymers, as capped prepolymer and as fully reacted polyurethanes in the form of a melt or solution. More specifically these are:
polyols in the form of polyethers, e.g., polyethylene glycol 400, Voranol® P 400 and Voranol® CP 3055 from Dow Chemicals, polyesters, e.g., Lupraphen® 8107, Lupraphen® 8109 from Elastorgan® GmbH, Desmophen® 670, Desmophen® 1300 from Bayer AG, Oxyester® T 1136 from Degussa AG, alkyd resins, e.g., Worléekyd® C 625 from Worlée Chemie GmbH,
polycarbonates, e.g., Desmophen® C 200, hydroxy-containing polyacrylates, e.g., Desmophen® A 365 from Bayer AG,
polyisocyanates, e.g., Desmodur® N 3300, Desmodur® VL, Desmodur® Z 4470, Desmodur® IL or Desmodur® L 75 from Bayer AG, Vestanat® T 1890 L from Degussa AG, Rodocoat® WT 2102 from Rhodia Syntech GmbH,
polyurethane prepolymers, e.g., Desmodur® E 4280 from Bayer AG, Vestanat® EP-U 423 from Degussa AG,
PMMA and further poly(meth)alkyl acrylates, e.g., Plexisol® P 550 and Degalan® LP 50/01 from Degussa AG,
polyvinyl butyral and other polyvinyl acrylates, e.g., Mowital® B 30 HH from Clariant GmbH,
polyvinyl acetate and its copolymers, e.g., Vinnapas® B 100/20 VLE from Wacker-Chemie GmbH.

For all of the polymers both the aliphatic and the aromatic versions are expressly included. The binder may also be chosen such that it is identical with the silane used for functionalization.

The binders preferably have a molar weight of 100 to 800 g/mol. The binder content of the coating composition as a whole is preferably 80% to 99%, more particularly 90% to 99% by weight.

The coating compositions of the invention may further comprise additional adjuvants of the kind typical in coatings technology, examples being reactive diluents, solvents and cosolvents, waxes, matting agents, lubricants, defoamers, deaerating agents, flow control agents, thixotropic agents, thickeners, organic and inorganic pigments, fillers, adhesion promoters, corrosion inhibitors, anticorrosion pigments, UV stabilizers, HALS compounds, free-radical scavengers, antistats, wetting agents, and dispersants and/or the catalysts, cocatalysts, initiators, free-radical initiators, photoinitiators, photosensitizers, etc. that are necessary depending on the mode of curing. Suitable further adjuvants also include polyethylene glycol and other water retention agents, PE waxes, PTFE waxes, PP waxes, amide waxes, FT paraffins, montan waxes, grafted waxes, natural waxes, macrocrystalline and microcrystalline paraffins, polar polyolefin waxes, sorbitan esters, polyamides, polyolefins, PTFE, wetting agents or silicates.

The examples which follow are intended to illustrate the subject matter of the invention in greater detail without restricting the possible diversity.

### EXAMPLES

### Example 1

A 50% strength aqueous solution of aluminum chlorohydrate was admixed with magnesium chloride such that after calcination the ratio of aluminum oxide to magnesium oxide was 99.5:0.5%. Added additionally to this solution was 2% of crystallization nuclei of a suspension of ultrafine corundum. When the solution had been homogenized by stirring, drying took place in a rotary evaporator. The solid aluminum chlorohydrate/magnesium chloride mixture was comminuted in a mortar to give a coarse powder.

The powder was calcined in a rotary tube furnace at 1050° C. The contact time in the hot zone was a maximum of 5 minutes. This gave a white powder whose grain distribution corresponded to the feed material.

X-ray structural analysis shows that predominantly α-aluminum oxide is present.

The images of the SEM (scanning electron microscope) micrograph taken showed crystallites in the range 10-80 nm (estimation from SEM micrograph), in the form of agglomerates. The residual chlorine content was just a few ppm.

In a further step, 40 g of this corundum powder doped with magnesium oxide were suspended in 160 g of isopropanol. The suspension was admixed with 40 g of trimethoxyoctylsilane and supplied to a vertical stirred ball mill from Netzsch (type PE 075). The grinding beads employed were of zirconium oxide (stabilized with yttrium) and had a size of 0.3 mm. After three hours, the suspension was separated from the grinding beads and boiled under reflux for a further 4 h. Subsequently the solvent was removed by distillation and the wet residue that remained was dried in a drying cabinet at 110° C. for a further 20 h.

### Example 2

40 g of the oxide mixture (MgO-doped corundum) from example 1 were suspended in 160 g of methanol and the suspension was deagglomerated in a vertical stirred ball mill from Netzsch (type PE 075). After 3 h the suspension was separated from the beads and transferred to a round-bottomed flask with reflux condenser. The suspension was admixed with 40 g of trimethoxyoctylsilane and heated under reflux for 2 h. Following removal of the solvent, the coated oxide mixture was isolated and dried in a drying cabinet at 110° C. for a further 20 h. The resulting product is identical to the sample from example 1.

### Example 3

40 g of the oxide mixture (MgO-doped corundum) from example 1 were suspended in 160 g of methanol and the suspension was deagglomerated in a vertical stirred ball mill from Netzsch (type PE 075). After 2 h 20 g of 3-(trimethoxysilyl)propyl methacrylate (Dynasilan Memo; Degussa) were added and the suspension was deagglomerated in the stirred ball mill for a further 2 h. Subsequently the suspension was separated from the beads and transferred to a round-bottomed flask with reflux condenser. It was heated under reflux for a further 2 h, after which the solvent was removed by distillation.

### Example 4

40 g of the oxide mixture (MgO-doped corundum) from example 1 were suspended in 160 g of acetone and the suspension was deagglomerated in a vertical stirred ball mill from Netzsch (type PE 075). After 2 h 20 g of aminopropyltrimethoxysilane (Dynasilan Ammo; Degussa) were added and the suspension was deagglomerated in the stirred ball mill for a further 2 h. Subsequently the suspension was separated from the beads and transferred to a round-bottomed flask with reflux condenser. It was heated under reflux for a further 2 h, after which the solvent was removed by distillation.

### Example 5

40 g of the oxide mixture (MgO-doped corundum) from example 1 were suspended in 160 g of acetone and the suspension was deagglomerated in a vertical stirred ball mill from Netzsch (type PE 075). After 2 h 20 g of glycidyltrimethoxysilane (Dynasilan Glymo; Degussa) were added and the suspension was deagglomerated in the stirred ball mill for a further 2 h. Subsequently the suspension was separated from the beads and transferred to a round-bottomed flask with reflux condenser. It was heated under reflux for a further 2 h, after which the solvent was removed by distillation.

### Example 6

40 g of the oxide mixture (MgO-doped corundum) from example 1 were suspended in 160 g of n-butanol and the suspension was deagglomerated in a vertical stirred ball mill from Netzsch (type PE 075). After 2 h a mixture of 5 g of aminopropyltrimethoxysilane (Dynasilan Ammo; Degussa) and 15 g of octyltriethoxysilane was added and the suspension was deagglomerated in the stirred ball mill for a further 2 h. The suspension remains stable for weeks without signs of sedimentation of the coated mixed oxide.

### Use Examples

The coated mixed oxides from the examples were tested in various varnish systems for their abrasion resistance, hardness, gloss, and scratch resistance. The tests take place in a 2-component polyurethane varnish system, a 100% UV varnish system, and a 1-component baking varnish system.

### I. 2-Component Polyurethane Varnish System

The samples from examples 1-3 were dispersed into the 1st component and/or into a solvent of the varnish system.

### Abrasion

Using a compressed air gun, the varnish samples were applied to special glass plates.

Using the Taber Abraser, after different numbers of rotations, the masses were determined and hence the abrasion calculated.

| | after 20 | after 50 | after 100 |
|---|---|---|---|
| Masses [mg] | rotations | rotations | rotations |
| Varnish without additives | 0.4 | 2.1 | 5.6 |
| 2% mixed oxide nanoparticles/ex. 3 | 0.0 | 1.0 | 3.9 |
| 4% mixed oxide nanoparticles/ex. 3 | 0.0 | 2.8 | 3.8 |
| 2% mixed oxide nanoparticles/ex. | 0.5 | 1.1 | 3.8 |
| 1 or 2 | | | |
| 4% mixed oxide nanoparticles/ex. | 0.5 | 1.7 | 4.1 |
| 1 or 2 | | | |
| 10% mixed oxide nanoparticles/ex. | 0.8 | 2.2 | 4.8 |
| 1 or 2 | | | |
| 2% Nanobyk-3610 | 0.0 | 2.2 | 4.8 |

Nanobyk-3610 is a dispersion of surface-modified nanoaluminum in methoxypropyl acetate as solvent for the purpose of improving the scratch resistance.

### Gloss

The varnishes were applied with a 60 μm wet film thickness to glass plates, and the gloss was determined by means of the BYK-Gardner micro-gloss, at an angle of 60°.

| | Gloss/60° |
|---|---|
| No additive | 144 |
| 2% mixed oxide nanoparticles/ex. 3 | 133 |
| 4% mixed oxide nanoparticles/ex. 3 | 129 |
| 4% mixed oxide nanoparticles/ex. 1 or 2 | 126 |
| 6% mixed oxide nanoparticles/ex. 1 or 2 | 120 |
| 10% mixed oxide nanoparticles/ex. 1 or 2 | 110 |
| 2% Nanobyk-3610 | 101 |

### Pencil Hardness

The hardness of the varnish films on the glass plates was determined by the Wolff-Wilborn pencil hardness method.

| | Hardness |
|---|---|
| No additive | F |
| 10% mixed oxide nanoparticles/ex. 1 or 2 | F |
| 6% mixed oxide nanoparticles/ex. 1 or 2 | F |
| 4% mixed oxide nanoparticles/ex. 1 or 2 | H |
| 4% mixed oxide nanoparticles/ex. 3 | H |
| 4% mixed oxide nanoparticles/ex. 3 | H |
| 2% Nanobyk-3610 | HB |
| Soft | |
| 6B | |
| 5B | |
| 4B | |
| 3B | |
| 2B | |
| B | |
| HB | |
| F | |
| H | |
| 2H | |
| 3H | |
| 4H | |
| 5H | |
| 6H | |
| 7H | |
| 8H | |
| 9H | |
| Hard | |

### II. 100% UV Varnish System

The samples from examples 1-3 were dispersed into the varnish system.

### Abrasion

Using a compressed air gun, the varnish samples were applied to special glass plates.

Using the Taber Abraser, after different numbers of rotations, the masses were determined and hence the abrasion calculated.

| | 50 | 100 | 200 |
|---|---|---|---|
| Mass [mg] | rotations | rotations | rotations |
| Without additives | 1.5 | 3.9 | 10.5 |
| 2% mixed oxide nanoparticles/ex. 3 | 0.9 | 2.5 | 7.1 |
| Mixed oxide nanoparticles/ex. 1 or 2 | 1.3 | 3.2 | 9.0 |
| 2% Nanobyk-3601 | 1.5 | 3.3 | 8.3 |

Nanobyk-3601 is a dispersion of surface-modified nanoaluminum in tripropylene glycol diacrylate for the purpose of improving the scratch resistance.

### Gloss

The varnishes were applied with a 60 μm wet film thickness to glass plates, and the gloss was determined by means of the BYK-Gardner micro-gloss, at an angle of 60°.

| | Gloss |
|---|---|
| No additive | 139 |
| 2% mixed oxide nanoparticles/ex. 3 | 137 |
| 2% mixed oxide nanoparticles/ex. 1 or 2 | 120 |
| 2% NANOBYK-3601 | 134 |

### Pencil Hardness

The hardness of the varnish films on the glass plates was determined by the Wolff-Wilborn pencil hardness method.

| | Hardness | |
|---|---|---|
| No additive 2% mixed oxide nanoparticles/ex. 3 2% mixed oxide nanoparticles/ex. 1 or 2 2% Nanobyk-3601 | H H 2H 2H | 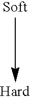 |

### III. 1-Component Baking Varnish System

The samples from examples 4 to 6 were dispersed into the varnish and/or into a solvent of the varnish system.

### Abrasion

Using a compressed air gun, the varnish samples were applied to special glass plates.

Using the Taber Abraser, after different numbers of rotations, the masses were determined and hence the abrasion calculated.

| | after 100 | after 200 |
|---|---|---|
| Masses [mg] | rotations | rotations |
| Varnish without additives | 10.4 | 23.9 |
| 2% mixed oxide nanoparticles/ex. 4 | 7.0 | 19.0 |
| 2% mixed oxide nanoparticles/ex. 5 | 7.5 | 21.2 |
| 5% mixed oxide nanoparticles/ex. 4 | 7.4 | 18.4 |
| 5% mixed oxide nanoparticles/ex. 5 | 5.6 | 12.3 |
| 2% Nanobyk-3610 | 12.5 | 25.4 |
| Varnish without additives | 16.0 | 31.6 |
| 2% mixed oxide nanoparticles/ex. 6 | 12.0 | 25.4 |
| 4% mixed oxide nanoparticles/ex. 6 | 11.3 | 23.8 |

### Gloss

The varnishes were applied with a 60 μm wet film thickness to glass plates, and the gloss was determined by means of the BYK-Gardner micro-gloss, at an angle of 60°.

| | Gloss |
|---|---|
| No additive | 154 |
| 2% mixed oxide nanoparticles/ex. 4 | 150 |
| 2% mixed oxide nanoparticles/ex. 5 | 138 |
| 5% mixed oxide nanoparticles/ex. 4 | 146 |
| 5% mixed oxide nanoparticles/ex. 5 | 123 |
| 2% Nanobyk-3610 | 142 |
| No additive | 154 |
| 2% mixed oxide nanoparticles/ex. 6 | 142 |
| 4% mixed oxide nanoparticles/ex. 6 | 130 |

### Scratch Hardness Test

The varnishes were applied with a 60 μm wet film thickness to tin plate panels, and the scratch hardness was determined via the number of strokes.

| | 100 g weight |
|---|---|
| No additive | 9 |
| 2% mixed oxide nanoparticles/ex. 4 | 26 |
| 2% mixed oxide nanoparticles/ex. 5 | 16 |
| 5% mixed oxide nanoparticles/ex. 4 | 12 |
| 5% mixed oxide nanoparticles/ex. 5 | 21 |
| 2% Nanobyk-3610 | 4 |
| | 300 g weight |
| No additive | 5 |
| 2% mixed oxide nanoparticles/ex. 6 | 7 |
| 4% mixed oxide nanoparticles/ex. 6 | 6 |

1. A coating composition comprising mixed oxide nanoparticles, the mixed oxide nanoparticles being composed of 50%-99.9% by weight of aluminum oxide and 0.1%-50% by weight of oxides of elements of main group I or II of the periodic table of the elements, wherein the mixed oxide nanoparticles are formed by deagglomeration of agglomerates of the mixed oxide nanoparticles, and wherein the deagglomeration is achieved by grinding the mixed oxide nanoparticles in a solvent.

2. The coating composition as claimed in claim 1, wherein the mixed oxide nanoparticles are modified on the surface with a coating material, wherein the surface modified nanoparticles are formed by deagglomeration of agglomerates consisting of the mixed oxide nanoparticles, and wherein the deagglomeration is achieved by grinding in a solvent and simultaneous treatment with the coating material.

3. The coating composition as claimed in claim 1, wherein the mixed oxide nanoparticles are modified on the surface with a coating material, wherein the surface modified nanoparticles are formed by deagglomeration of agglomerates consisting of the mixed oxide nanoparticles, and wherein the deagglomeration is achieved by grinding in a solvent and subsequent treatment with the surface-modifying coating material.

4. A varnish comprising the coating composition as claimed in claim 1.
